(19) United States
(12) Patent Application Publication
(10) Pub. No.: US 2003/0180419 A1
(43) Pub. Date: Sep. 25, 2003

(54) Method for processing coffee and product produced thereby

(76) Inventor: Michael Calderone, Las Vegas, NV (US)

Correspondence Address: Anderson & Morishita, L.L.C., Suite 102, 2725 S. Jones Blvd., Las Vegas, NV, 89146, US

(21) Appl. No.: 10/104,040

(22) Filed: Mar. 22, 2002

(51) Int. Cl. A23B 4/00

(52) U.S. Cl. 426/107

(57) ABSTRACT

A method for processing coffee and a product by the method is set forth. The method includes partially roasting and then packaging the partially roasted coffee beans in a micro-wavable, sealed, package for distribution in commerce. The end user microwaves the package to complete roasting to the desired degree. The beans are then ground and brewed.

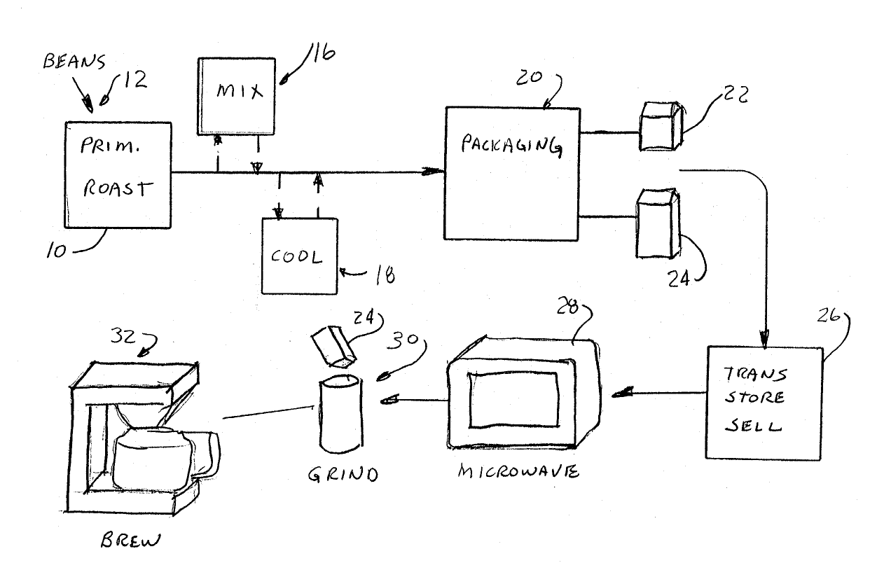

### FIELD OF THE INVENTION

The present invention relates to a process coffee of pre-partial roasting of coffee, specialized packaging and completion of the roasting process by the consumer in a controlled environment provided by the specialized packaging.

### BACKGROUND

Roasting of coffee for commercial use is old and well known. It has been known to provide for gas fired roasting ovens to roast the coffee beans to drive off residual moisture and facilitate the chemical changes in the bean. After roasting, the beans are packaged and shipped to stores for sale to the ultimate end user. The roasted beans can be sold in bulk or in pre-packaged containers or packages. The end user grinds and brews the coffee at home or, if the user is a restaurant, at the restaurant. It is also known to grind the beans and package the same in cans or in bags.

Regarding coffee roasting, several techniques have been employed in an effort to produce better tasting coffee. In Gillies, U.S. Pat. No. 116,298 issued Jun. 27, 1871, a two step roasting process using a fired roasting oven is disclosed. Maede, U.S. Pat. No. 1,915,372 issued Jun. 27, 1933 also discloses a two-step roasting process using a fired burner, wherein the beans are first subjected to direct heat of the gas flame (and its products of combustion), cooled and later finally roasted in a gas fired, radiant oven where the beans are out of contact with the products of combustion. Maki et al, U.S. Pat. No. 5,681,607 issued Oct. 28, 1997 discloses a two-step steam roasting process.

Gerling et al U.S. Pat. No. 4,326,114 issued Apr. 20, 1982 there is disclosed microwave roasting of beans at varying power levels.

All of the above references contemplate complete roasting at the bean roasting facility, i.e. processing plant, to produce a completely roasted bean. The roasted beans would then be packaged for shipment, storage and sale. In this regard, it should be noted that heretofore, the roasted beans may be subjected to long shelf lives or extending periods of time between roasting and ultimate consumption by the end user coffee drinker. It is believed that the extended periods of time between completion of roasting affects the flavor of the coffee produced by the roasted beans. Exposure to the elements, air, temperature fluctuations and off-gassing form the beans where they are exposed to the environment during storage and shipment can tend to undesirably affect the flavor of coffee produced from the roasted beans.

Still further, the end user coffee drinker or vender, while he/she can affect the strength of the brewed coffee, the brewer has no influence as to the character and nature of the roasting process and hence the flavor of the coffee. The coffee as received by the consumer is in a completely roasted state.

It should further be noted that coffee consumers are seeking better flavored coffee at outside establishments as well as for their in-home consumption. Many coffee house franchises have emerged which prepare and sell brewed coffee by the cup as well as roasted coffee beans for the consumer to grind and brew at home. Many franchises have private labeled roasted beans for sale to the end user. Again, the flavor is affected by the elements noted above and the end user cannot influence the coffee flavor.

It is an object of the present invention to provide coffee beans packaged for sale where the end user consumer can influence the roasting process and flavor.

It is a further object of the present invention to provide coffee which is fresher and of a better flavor.

It is still another object of the present invention where the flavor of the coffee bean is preserved until just prior to brewing.

### SUMMARY OF THE INVENTION

There is, therefore, provided according to the present invention a method where the end user consumer can complete roasting just prior to grinding of the beans for brewing coffee and where the end user can influence flavor by controlling final roasting step. Also provided is a packaged coffee product containing partially roasted beans which is microwave safe and is intended to be placed directly in the end user's microwave to complete roasting. The aforesaid package may be sized according to the number of brewed cups of coffee desired.

The method of the present invention broadly includes first partially roasting coffee beans at a roasting facility to a predetermined point of incomplete roasting. The predetermined point may be based on the nature of the coffee bean variety and characteristics such as the point where the bean begins to expand and de-chaff or the point where the bean turns a designated color. The partially roasted beans are then packaged in a microwave-compatible package, preferably sealed air tight, for storage, shipment and sale. The packaging is preferably sized based upon the desired amount of brewed coffee which will be produced from the contained beans, e.g. 4 cups, 10-12 cups, etc.

Prior to grinding the beans for brewing, the package and contained partially roasted beans are placed in a microwave to complete roasting of the beans. Under microwave heating, the beans expand and degas to expand the package. Because the end user completes roasting, they can finally roast the beans to a desired flavor condition. For example, the end user can increase/decrease the microwave roasting time or repeat a microwave roasting period for a darker roast.

After roasting, the package is opened and the freshly and finally roasted coffee beans are ground for brewing of coffee.

Also set forth is a method and product produced by the method directed to the packaging containing the partially roasted beans.

### BRIEF DESCRIPTION OF THE DRAWINGS

These and other features and advantages will become appreciated as the same becomes better understood with reference to the description, claims and drawing which is a process flow diagram showing the method(s) and product of the present invention.

### DESCRIPTION

The method of the present invention includes a primary, partial roast of the beans in any suitable roaster such as a fluid bed roaster 10. The dried, raw beans are introduced into the roaster 10 at 12 and are partially roasted to a predetermined condition. This predetermined, partially roasted condition may depend upon the nature of the beans and other conditions such as altitude where roasting is taking place, whether any flavoring has been added to the bean, whether the coffee is decaffeinated, etc. The following Table 1 shows some examples the primary, partial roasting of the beans. Where mixing of the partially roasted beans is required, the beans are sent to a mixer 16.

TABLE 1

| Blend Name | Blend Components | Roasting Procedure |
|---|---|---|
| Kona Blend | 20% Kona; 80% Central or | Mix green; roast to 440° F. |
| | South American, Mexican, | in fluid bed roaster |
| | Peruvian etc. | |
| French Roast | 30% Nicaraguan, 30% | Mix green; roast in drum |
| | Panama, 0% Ethiopian; 30% | roaster to 380° F. |
| | Sumatra | |
| Vienna | 50% French Roast; 50% | Roast French Roast per |
| Blend | Columbian Supremo | procedure above; Roast |
| | | Columbian Supremo in |
| | | fluid bed to 440° F. |
| | | Mix after roasting |
| Columbian | 100% Columbian | Roast in fluid bed roaster to |
| Supremo | | 440° F. |
| Signature | ⅓ French Roast; ⅓ | Prepare French Roast and |
| Blend | Columbian Supremo; ⅓ | Columbian per procedure |
| | Brazilian | above; Roast Brazilian in |
| | | fluid bed roaster to 425° F. |
| | | Mix after roasting. |
| Premium | 60% French Roast; 40% | Prepare French Roast and |
| Expresso | Brazilian | Brazilian per above |
| | | procedure. Mix after |
| | | roasting. |
| Kenya | 100% Kenya | Roast in fluid bed roaster to |
| | | 445° F. |
| Sumatra | 100% Sumatra | Roast in fluid bed roaster to |
| | | 442° F. |
| Columbian | 100% Columbian Decaf | Roast in fluid bed roaster to |
| Decaf Roast | | 433° F. |
| French Roast | 25% Ethiopian; 25% Costa | Roast in drum roaster to |
| Decaf | Rican, 25% Sumatra, 25% | 382° F. |
| | Brazilian Decaf | |
| Flavored | Mexican, Peruvian etc | Roast in fluid bed roaster |
| Coffees | | then flavor with premium |
| | | grade flavor (French |
| | | Vanilla, Irish Crème, |
| | | Hazel Nut, Haise) |

The partial roasting of the beans to the suggested temperatures is to a point where the beans begin to expand and de-chaff their skin and beans begin to change color to a light brown or medium light brown. At this point the beans have lost about 60% to 80% of their moisture.

While not required, but preferably, the partially roasted beans are then cooled rapidly in a cooler 18 to discontinue the roasting process. The cooler 18 may be any suitable cooler such as a refrigeration unit, water cooled unit, air cooled unit or the like. During cooling, the partially roasted beans should be segregated from the cooling medium.

After cooling, and preferably within 18-24 hours of partial roasting, the partially roasted beans are sent to the packaging unit 20 where they are packaged in sealed, air-tight, expandible, microwave compatible packaging such as bags 22, 24 fashioned from a sturdy microwave compatible film such as clear laminate film, structure 48/002 LLDPE white, size: 11.5″ web. Other microwave compatible packaging can be used as well such as Styrofoam containers or the like. In this regard, the packaging is sealed airtight. Where cooling is not desired, the warm, partially roasted beans may be directly packaged after partially roasting in the roaster 10, with the cooling of the beans taking place in the packaging. By placing the partially roasted beans in the air tight packaging, any further degassing of the beans creates, in the sealer, air tight, packaging, a gas blanket for the beans to preserve the flavor of the beans.

It should be noted that preferably the packaging such as bags 22, 24, is adapted to hold beans sufficient such that when they are ground and brewed will produce a predetermined amount of brewed coffee. For example, bag 24 may be a 10-12 cup bag and bag 22 a 4 cup bag. The package could also be in one pound sizes as well. As stated above, after the partially roasted beans are packaged, the package is sealed. To facilitate later processing of the package and partially roasted beans, the packaging contains instructions for the end user to complete roasting as hereinafter described.

The sealed bags 22, 24 are then ready for storage, shipment and ultimate sale to an end user at 26. It should be noted that over time the packaged beans may tend to degas; however, the sealed packaging contains the off gases which act to shield the partially roasted beans from air and oxygenation of the beans and blanket. The end user may be a ultimate, in-home, consumer of the coffee, a restaurant, coffee house or the like. For purposes of discussion it shall be assumed that the end user is a consumer who desires to brew coffee at home.

The consumer/end user buys the packaged, partially roasted coffee and takes it home. At home the end user places the package in their microwave 28 to microwave heat the beans to complete roasting thereof. Table 2 below suggests some microwave instructions which may be provided with the package for completion of the roasting process.

TABLE 2

| Microwave Power | Instructions |
|---|---|
| Low Power (≦900 W) | Place package in middle of microwave and roast |
| | don high setting for 2 minutes. For darker roast, |
| | repeat |
| Regular Power | Place package in middle of microwave and roast |
| 900-1100 W | on high setting for1 minute. For darker roast, |
| | repeat |
| High Power ≧ | Place package in middle of microwave and roast |
| 1100 W | on high setting for 40 seconds. For darker roast, |
| | repeat |

It should be noted that if the consumer during the microwave, finish roasting, hears the beans crackle, they are over-roasting the beans. A degree of steam and gas is to be expected during the finish, microwave roasting.

The consumer can experiment with roasting times and powers to obtain the desired flavors.

After roasting, the package is removed from the microwave 28, the air tight package is opened and the roasted beans are placed in a coffee grinder 30 to grind the beans. The ground beans are then brewed into coffee at a coffee maker 32.

Since the beans are finish roasted by the consumer just prior to grinding and roasting, they retain their fresh, roasted, flavor. Further, the consumer can control and experiment with the finish roasting to produce the desired roasting level of the beans.

If a flavor is desired to be added to the coffee, flavoring may be added to the partially roasted beans as by soaking the or spraying the beans with a flavoring or flavoring may be added prior to the primary roasting.

While I have described certain embodiments of the present invention, it is to be understood that it is subject to many modifications without departing from the spirit and scope of the appended claims.

I claim:

1. A method for processing coffee comprising:
partially roasting coffee beans to a predetermined point of incomplete roasting;
packaging the partially roasted beans in a microwave compatible package; and
prior to grinding and brewing, micro-waving the package and contained partially roasted beans to complete roasting.

2. The method of claim 1 comprising partially roasting the beans to a point to expand and de-chaff the beans.

3. The method of claim 1 comprising cooling the beans prior to packaging.

4. The method of claim 1 comprising packaging the partially roasted beans in a closed package.

5. The method of claim 4 comprising packaging the partially roasted beans in a sealed package.

6. The method of claim 1 comprising partially roasting the beans at temperatures between approximately 380 degrees and 450 degrees.

7. The method of claim 1 comprising micro-waving the partially roasted beans for approximately between 1 and 2 minutes.

8. The method of claim 1 comprising packaging the partially roasted beans in a predetermined serving size microwave compatible package.

9. A method for preparing a package to enable an end user to complete roasting of coffee beans prior to grinding and brewing, said method comprising:
partially roasting coffee beans to a predetermined point of incomplete roasting; and
packaging the partially roasted beans in a microwave compatible, sealed package for sale to the end user.

10. The method of claim 9 comprising the end user micro-waving the package to complete roasting.

11. A package product according to the method of claim 9.

12. A packaged product for an end user to produce roasted coffee for grinding and brewing comprising:
said package is fashioned from micro-wave compatible components;
partially roasted coffee beans disposed in the sealed package, whereby the end user places the package in a microwave to complete roasting for grinding and brewing of the coffee.

13. The package of claim 12 wherein said package is fashioned from a micro-wavable film.

14 The package of claim 12 wherein said package contains partially roasted beans sufficient to make, when brewed, a predetermined amount of coffee.

15. The package of claim 12 comprising an air sealed package containing said partially roasted beans.
